(19) United States
(12) Patent Application Publication
(10) Pub. No.: US 2007/0008284 A1
(43) Pub. Date: Jan. 11, 2007

(54) Mouse with built-in microphone

(76) Inventors: Do-Hwi Kim, Seongnam-si (KR); Oan-Kyu Choi, Suwon-si (KR)

Correspondence Address: CANTOR COLBURN, LLP, 55 GRIFFIN ROAD SOUTH, BLOOMFIELD, CT, 06002, US

(21) Appl. No.: 11/481,085

(22) Filed: Jul. 5, 2006

(30) Foreign Application Priority Data
Jul. 11, 2005 (KR) 10-2005-0062455

(51) Int. Cl. G09G 5/08

(52) U.S. Cl. 345/163

(57) ABSTRACT

Provided is a wired or wireless mouse, one of peripheral devices of a computer. The mouse is capable of installing a built-in microphone in the mouse without a design change of a mouse surface, outputting a voice signal from the microphone to a soundcard of a computer through a separate output line different from an output line of the mouse, removing noise generated when a voice signal is output during operation of the mouse, transmitting the voice signal to the computer through the microphone even while an application program is executed in the computer through the mouse, and improving sensitivity of the voice signal input into the computer.

### CROSS-REFERENCE TO RELATED APPLICATION

This application claims the benefit of Korean Patent Application No. 10-2005-0062455, filed Jul. 11, 2005, the disclosure of which is hereby incorporated herein by reference in its entirety.

### BACKGROUND OF THE INVENTION

1. Field of the Invention

The present invention relates to a wired or wireless mouse, one of computer peripheral devices, and more particularly, to a mouse with a built-in microphone capable of transmitting a voice signal from the microphone included in the mouse to a computer through a separate output line regardless of the operation of the mouse, and removing various noises generated during the operation of the mouse to improve sensitivity of the voice signal transmitted from the microphone to the computer.

2. Description of the Related Art

As is well known, a mouse, one of peripheral devices of a computer, is classified into a wired mouse and a wireless mouse, and each of the wired and wireless mice is classified into a ball mouse and an optical mouse.

The mouse commonly includes a left function button, a right function button and a scroll button at its upper surface although not shown. In addition, in order to control movement of a curser of a computer monitor, the optical mouse includes means for radiating light, and the ball mouse includes a ball, at its lower surface.

Meanwhile, a conventional mouse with a built-in microphone has been developed to output a voice signal to a computer through the microphone.

However, it is troublesome to change design of a mouse surface for mounting the microphone in the conventional mouse. In addition, since a voice signal output to the computer through the microphone is output through an output line of the mouse in a sharing manner, various noises generating during operation of the mouse, e.g., click of the left and right function buttons of the mouse, friction noise between the mouse and a bottom surface of a mouse pad or a desk, click of the scroll button, and so on are included in the voice signal, thereby lowering sensitivity of the voice signal.

In order to solve these problems, there has been disclosed a technology capable of muting the voice signal output through the microphone while the mouse operates, and outputting the voice signal through the microphone only when the mouse does not operate. However, in this case, since most operations of the computer are performed through the mouse, it is impossible to use the computer while the voice signal is transmitted through the mouse.

Therefore, the conventional mouse with a built-in microphone may be limited in use because the microphone is turned off while the mouse operates and the voice signal can be transmitted to the computer through the microphone only when the mouse does not operate.

### SUMMARY OF THE INVENTION

In order to solve the foregoing and/or other problems, the present invention provides a mouse with a built-in microphone capable of outputting a voice signal from the microphone to a soundcard of a computer through a separate output line different from an output line of the mouse, removing noise generated when a voice signal is output during operation of the mouse, transmitting the voice signal to the computer through the microphone even while an application program is executed in the computer through the mouse, and improving sensitivity of the voice signal input into the computer.

The present invention also provides a mouse with a built-in microphone capable of installing the microphone in the mouse without a design change of a mouse surface to remove inconvenience of the design change of the mouse surface for installing the conventional microphone therein, and therefore, reduce the cost required for the design change.

According to an aspect of the present invention, there is provided a mouse with a built-in microphone comprising: a first surface having a left function button, a right function button, and a scroll button; a second surface having an optical structure for setting coordinates; a printed circuit board disposed between the first and second surfaces; a microphone installed between the first and second surfaces and electrically connected to the printed circuit board to receive a voice signal; a data transmission line for transmitting mouse signals including click signals and a coordinate setting signal from the buttons and the optical structure disposed in the first and second surfaces; and a signal processor for processing the voice signal input from the microphone, wherein the voice signal processed by the signal processor is transmitted together with the mouse signals.

In another exemplary embodiment, the data transmission line may comprise a first communication unit for transmitting mouse signals including click signals and a coordinate setting signal, and a first data line for connecting the first communication unit to a computer.

In still another exemplary embodiment, the voice signal may be added to a standard protocol for transmitting the mouse signals.

In yet another exemplary embodiment, the mouse may further comprise a voice signal transmission line for transmitting only the voice signal processed through the signal processor to the computer.

In yet another exemplary embodiment, the voice signal transmission line may comprise a second communication unit for transmitting the voice signal only, and a second data line for connecting the second communication unit to the computer.

In yet another exemplary embodiment, the second data line may be connected to a soundcard module mounted in the computer.

In yet another exemplary embodiment, the signal processor may comprise a first converter (ADC) for converting an analog voice signal recognized through the microphone into a digital signal, and a digital signal processor (DSP) for removing noise input into the microphone.

In yet another exemplary embodiment, the signal processor may further comprise a second converter (DAC) for converting the digital voice signal, from which the noise is removed, into an analog signal, and transmitting the analog signal to the soundcard module mounted in the computer.

In yet another exemplary embodiment, the first surface may comprise a holder for fixing the microphone in an inner space of a first hole for protruding the scroll button.

In yet another exemplary embodiment, the second surface may comprise a holder installed in an inner space of a second hole for protruding the optical structure to the exterior.

In yet another exemplary embodiment, the holder may comprise a connection part for electrically connecting the printed circuit board and the microphone.

In yet another exemplary embodiment, the mouse may comprise a handsfree terminal electrically connected to the printed circuit board for connecting an earphone jack of a communication terminal for a voice call thereto.

### BRIEF DESCRIPTION OF THE DRAWINGS

The foregoing and other objects, features and advantages of the invention will be apparent from the more particular description of exemplary embodiments of the invention, as illustrated in the accompanying drawings. The drawings are not necessarily to scale, emphasis instead being placed upon illustrating the principles of the invention.

FIG. 1 is a perspective view of a mouse connected to a computer in accordance with a first exemplary embodiment of the present invention.

FIG. 2 is a schematic block diagram of a mouse for transmitting a mouse signal and a voice signal, from which noise is removed, to a computer in accordance with a first exemplary embodiment of the present invention.

FIG. 3 is a side cross-sectional view of a mouse having a microphone installed in a first surface in accordance with a first exemplary embodiment of the present invention.

FIG. 4 is a side cross-sectional view of a mouse having a microphone installed in a second surface in accordance with a first exemplary embodiment of the present invention.

FIG. 5 is a schematic block diagram of a mouse for directly transmitting a voice signal, from which noise is removed, to a soundcard module in accordance with a second exemplary embodiment of the present invention.

FIG. 6 is a schematic block diagram of a mouse for directly transmitting an analog voice signal, from which noise is removed, to a soundcard module in accordance with a third exemplary embodiment of the present invention.

FIG. 7 is a perspective view of a mouse connected to a communication terminal in accordance with a fourth exemplary embodiment of the present invention.

FIG. 8 is a schematic block diagram of FIG. 7 in accordance with a fourth exemplary embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions may be exaggerated for clarity. Like reference numerals designate like elements throughout the specification.

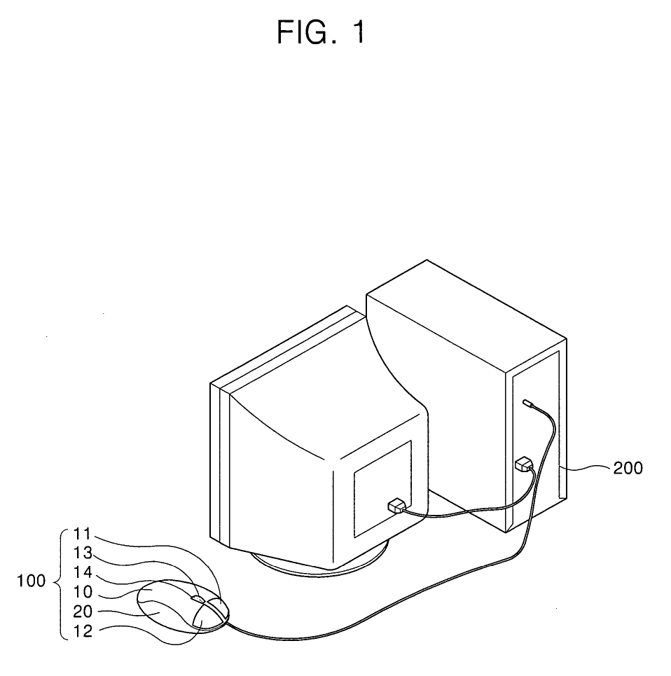

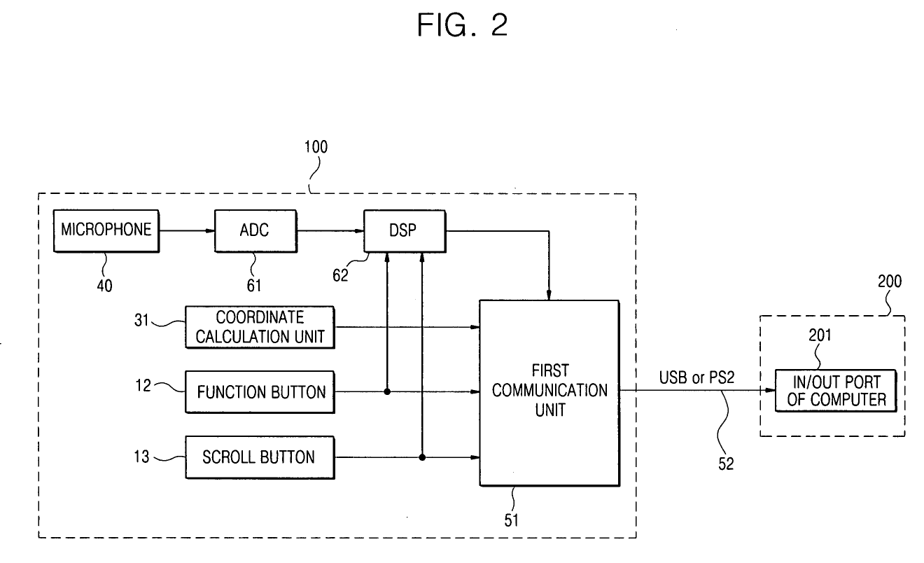

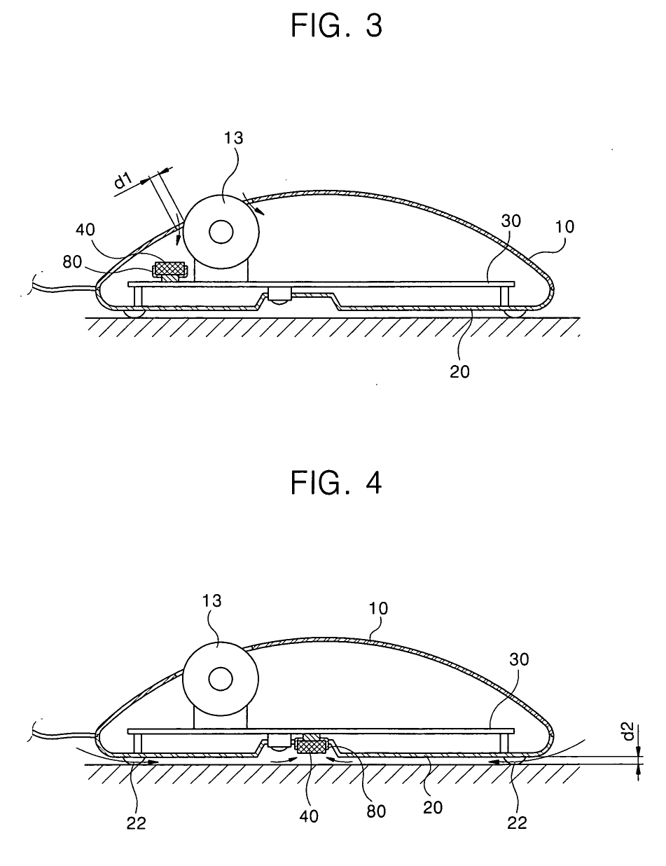

FIG. 1 is a perspective view of a mouse connected to a computer in accordance with a first exemplary embodiment of the present invention, FIG. 2 is a schematic block diagram of a mouse for transmitting a mouse signal and a voice signal, from which noise is removed, to a computer in accordance with a first exemplary embodiment of the present invention, FIG. 3 is a first cross-sectional view of a mouse in accordance with a first exemplary embodiment of the present invention, and FIG. 4 is a second cross-sectional view of a mouse in accordance with a first exemplary embodiment of the present invention.

Referring to FIGS. 1 to 4, a mouse 100 in accordance with a first exemplary embodiment of the present invention is connected to a computer 200, and includes first and second surfaces 10 and 20, a printed circuit board 30, a microphone 40, a data transmission line (not shown), and a signal processor (not shown).

The first surface 10 disposed at an upper part of the mouse 100 includes a left function button 11, a right function button 12, and a scroll button 13. The scroll button 13 is disposed in a first hole 14 provided at one end of the first surface 10 to protrude to the exterior.

The second surface 20 disposed at lower part of the mouse 100 includes an optical structure (not shown) for setting coordinates. The optical structure is disposed in a second hole (not shown) provided on a lower surface of the second surface 20.

The printed circuit board 30 is disposed between the first and second surfaces 10 and 20, and electrically connected to a coordinate calculation unit 31, the microphone 40, the data transmission line, and the signal processor.

The microphone 40 disposed between the first and second surfaces 10 and 20 is electrically connected to the printed circuit board 30 to receive a sound.

The data transmission line transmits mouse signals including click signals from the buttons 11, 12 and 13 disposed between the first and second surfaces 10 and 20 and a coordinate setting signal from the optical structure to the computer, and includes a first communication unit 51 and a first data line 52.

The first communication unit 51 transmits a function selection mouse signal from the left function button 11, the right function button 12, and the scroll button 13, and position information depending on movement of the mouse 100 calculated by the coordinate calculation unit 31 to the computer 200 through the first data line 52, as well as transmits a voice signal processed through the signal processor to the computer 200 through the first date line 52.

The first data line 52 connects the mouse 100 and the computer 200 to transmit the signals using the first communication unit 51, i.e., connects the first communication unit 51 of the mouse 100 to an in/out port 201 mounted on a main board of the computer 200. In this process, the first data line 52 may be formed in a wired or wireless manner. In the case of the wired manner, an electric wire is employed. In the case of the wireless manner, while not shown, an RF module including a wireless transmission unit installed in the mouse 100 and a wireless reception unit installed in the computer 200 may be employed, but not limited thereto.

The signal processor functions to process the voice signal input from the microphone 40. After processing the voice signal, the signal processor transmits the voice signal to the in/out port 201 of the computer 200 together with the mouse signals. The signal processor includes a first converter (ADC) 61 and a digital signal processor 62.

The first converter (ADC) 61 converts an analog voice signal of a user recognized by the microphone 40 into a digital signal. The digital signal processor 62 removes noise of the voice signal of the microphone 40, i.e., noise from the voice signal converted into the digital signal through the ADC 61, and then outputs the digital signal to the first communication unit 51 of the data transmission line.

In this process, the noise means click sounds when the left function button 11 and the right function button 12 are pushed, friction sounds when the mouse is moved, and click sounds caused by rotation of the scroll button 13.

In addition, while not shown, the computer 200 generally includes a communication unit connected to the first data line 52 and corresponding to the first communication unit 51.

Meanwhile, it is possible to install the microphone 40 between the first and second surfaces 10 and 20 constituting the mouse 100 in accordance with a first exemplary embodiment of the present invention shown in FIGS. 3 and 4, without forming any hole at outer surfaces of the surfaces 10 and 20.

Referring to FIG. 3, a holder 80 for fixing the microphone 40 is formed in an inner space of the first hole 14 for protruding the scroll button 13 from the first surface 10, and the microphone 40 is fixedly inserted into the holder 80.

Then, a user's voice can be transmitted to the microphone 40 in the inner space through a gap d1 between the scroll button 13 and the first hole 14.

At this time, the holder 80 includes a connection part (not shown) for electrically connecting the printed circuit board 30 and the microphone 40.

Referring to FIG. 4, the holder 80 for fixing the microphone 40 may be disposed at a connection part in an inner space of a second hole for protruding the optical structure from the second surface 20. In this case, the microphone 40 is also fixedly inserted into the holder 80.

At this time, the second surface 20 includes predetermined height of projections 22 at lower corners thereof so that the user's voice can be transmitted to the microphone 40 through a gap d2 generated due to the projections 22.

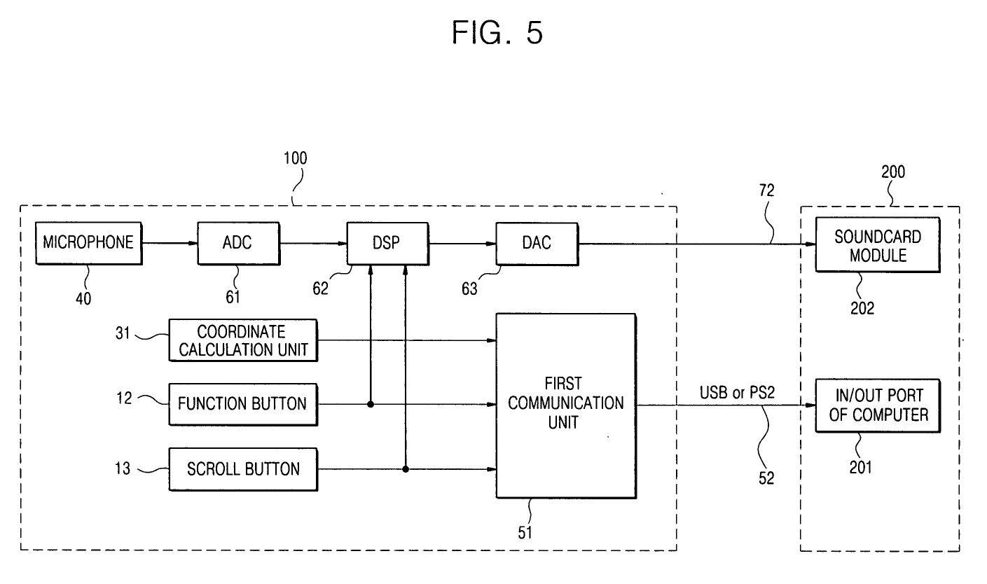

FIG. 5 is a schematic block diagram of a mouse in accordance with a second exemplary embodiment of the present invention, which further includes a second converter (DAC) 63 installed in the signal processor.

Specifically, the DAC 63 converts a digital voice signal, from which noise is removed by the digital signal processor 62, into an analog signal, and then transmits the analog signal to a soundcard module 202 mounted in the computer 200 through a second data line 72 for the exclusive use of voice. Therefore, it is possible to more reduce the noise generated from buttons of the mouse 100 and mouse signals for coordinate setting.

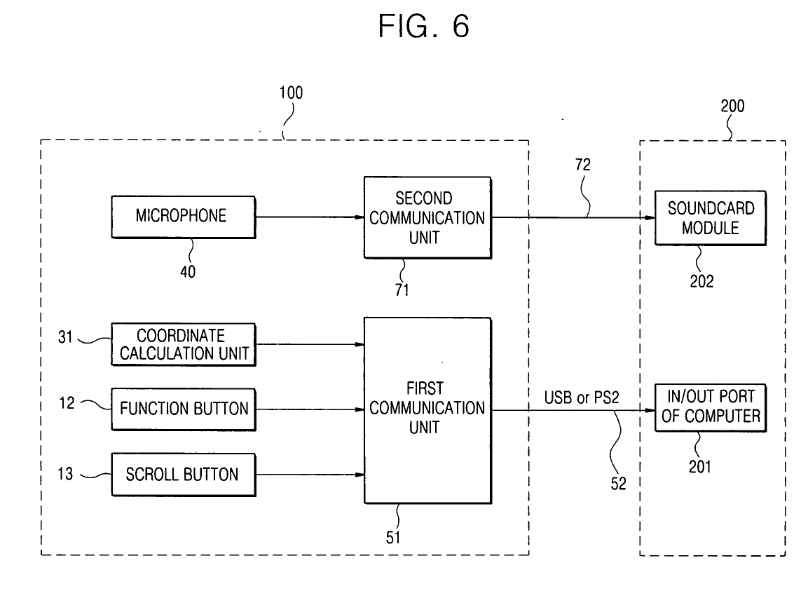

In addition, FIG. 6 is a schematic block diagram of a mouse in accordance with a third exemplary embodiment of the present invention, which further includes an exclusive voice transmission line for transmitting only a voice signal of the microphone 40 to the computer 200. The exclusive voice transmission line includes a second communication unit 71 and a second data line 72.

The second communication unit 71 directly transmits the analog voice signal input into the microphone 40 to the soundcard module 202, as a voice processor mounted in the computer 200 through the second data line 72. While not shown, the second communication unit 71 also outputs a flag signal, as an event signal for outputting the voice signal, to the in/out port 201 of the computer 200 through the first data line 52, thereby outputting the voice signal transmitted from the soundcard module 202 through a speaker.

The second data line 72 is connected to the soundcard module 202 mounted in the computer 200 in a wired or wireless manner. In the case of the wired manner, an electric wire is employed. In the case of the wireless manner, while not shown, an RF module including a wireless transmission unit installed at the mouse 100 and a wireless reception unit installed in the computer 200 may be employed, but not limited thereto.

In addition, when the second data line 72 is wired, the second data line 72 may be connected to the computer 200 through a coated wire or a separate universal serial bus (USB) port, but not limited thereto.

Further, while not shown, the computer 200 generally includes a communication unit connected to the second data line 72 and corresponding to the second communication unit 71.

At this time, the third exemplary embodiment of the present invention shown in FIG. 6 is more advantageous when the microphone 40 is disposed adjacent to the scroll button 13 or the optical structure, i.e., employed to an optical mouse.

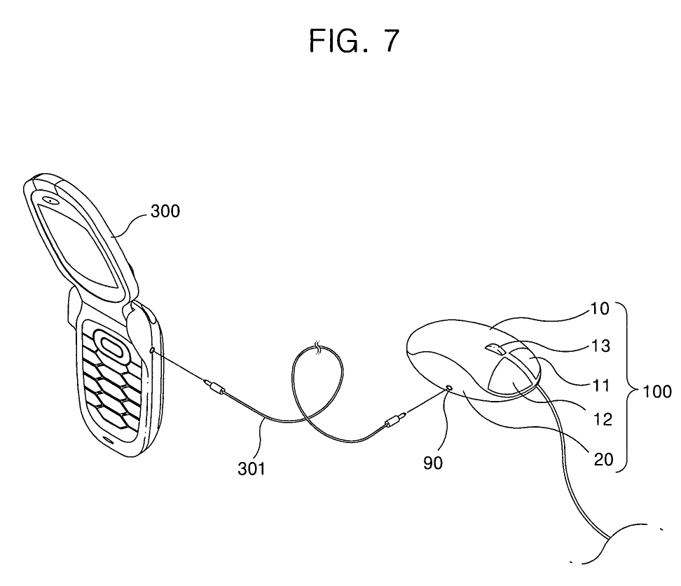

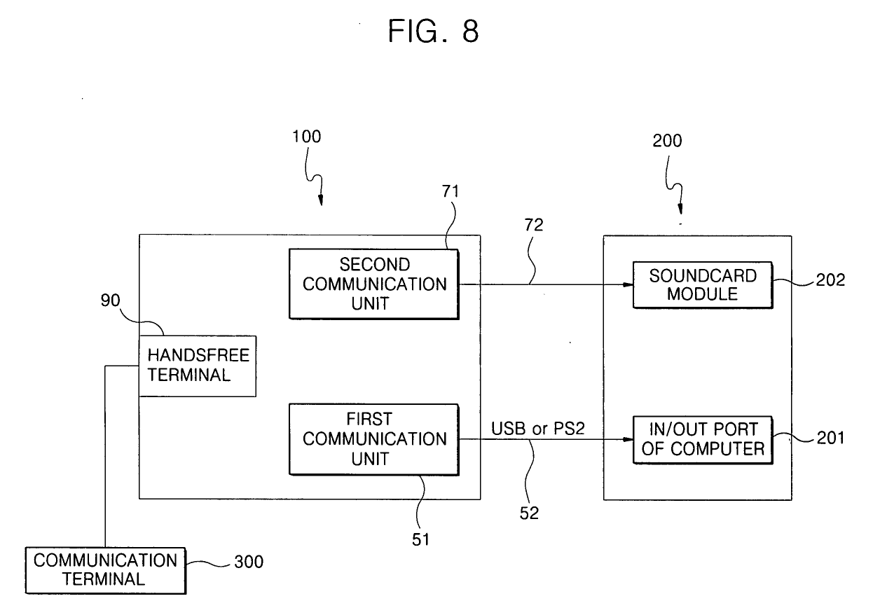

Meanwhile, FIG. 7 is a perspective view of a mouse connected to a communication terminal in accordance with a fourth exemplary embodiment of the present invention, and FIG. 8 is a schematic block diagram of FIG. 7 in accordance with a fourth exemplary embodiment of the present invention. In this process, a handsfree terminal 90 for inserting an earphone jack for a voice call of a communication terminal (for example, a mobile phone 300) is installed at one end of an outer surface of the mouse 100. At this time, the handsfree terminal 90 is connected to the printed circuit board 30 of the mouse 100.

The operation of the mouse in accordance with exemplary embodiments of the present invention will now be described in conjunction with FIGS. 1 to 8.

First, as shown in FIG. 3, after forming the holder 80 in an inner space of the first surface 10 having the scroll button 13, when the microphone 40 is inserted into the holder 80, the microphone 40 is electrically connected to the printed circuit board 30 installed in the mouse 100 through the connection part (not shown) in the holder 80, without a design change of the first and second surface 10 and 20 of the mouse 100.

Alternatively, after forming the holder 80 having the connection part in the second holder (not shown) of a space for mounting the optical structure formed at a bottom surface of the second surface 20, the microphone 40 may be installed in the holder 80, without a design change of the first and second surface 10 and 20 of the mouse 100.

Then, when the mouse 100 is connected to the computer 200, the first data line 52 of the mouse 100 is connected to the in/out port 201 mounted in a main board of the computer 200, and the second data line 72 of the mouse 100 is connected to the soundcard module 202, i.e., a sound processor, mounted in the computer 200.

Next, when the mouse 100 used in this state, the mouse signals from the coordinate calculation unit 31, the left and right function buttons 11 and 12, and the scroll button 13 are transmitted to the in/out port 201 of the computer 200 through the first communication unit 51 and the first data line 52 included in the mouse 100.

As a result, the computer 200 can execute a required application program on the basis of information input through the in/out port 201 of the computer 200, i.e., a coordinate value according to movement of the mouse and a click signal from the buttons.

Meanwhile, while the mouse is used, the user can input his/her voice into the microphone 40 installed in the mouse 100.

When the user's voice is input into the microphone 40, the voice is transmitted to the computer 200 in the same manner as shown in FIGS. 2, 5 and 6.

Specifically, in the case of FIG. 2, when an analog voice signal is input into the signal processor through the microphone 40, the analog voice signal is converted into a digital voice signal through the first converter (ADC) 61 included in the signal processor and then input into the digital signal processor 62, and the digital signal processor 62 removes noise from the input digital voice signal and outputs the digital voice signal to the first communication unit 51 included in the data transmission line.

Specifically, the digital signal processor 62 removes the noise included in the voice signal, i.e., click sounds of the left and right function buttons 11 and 12 generated during use of the mouse 100, friction sound between the mouse 100 and the bottom surface, and rotation sound of the scroll button 13, and then outputs the voice signal to the first communication unit 51.

Then, the first communication unit 51 transmits both the mouse signals such as the click signals and the coordinate setting signals, and the voice signal to the computer 200 through the first data line 52.

That is, the first communication unit 51 adds the voice signal to the standard protocol for transmitting the mouse signals, and then, transmits the resultant signal to the computer 200 through the first data line 52.

At this time, the computer 200 stores the voice signal input into the in/out port 210 through the first data line 52 in a memory, or executes a drive program of the soundcard module 202, thereby outputting the user's voice to the exterior through a speaker of the computer 200.

In addition, in the case of FIG. 5, when an analog voice signal is input into the signal processor through the microphone 40, the analog voice signal is converted into a digital voice signal through the first converter (ADC) 61 included in the signal processor and then input into the digital signal processor 62, and the digital signal processor 62 removes noise from the input digital voice signal and outputs the voice signal to the second converter (DAC) 63.

Specifically, the digital signal processor 62 removes the noise included in the voice signal, i.e., click sounds of the left and right function buttons 11 and 12 generated during use of the mouse 100, friction sound between the mouse 100 and the bottom surface, and rotation sound of the scroll button 13, and then, outputs the voice signal to the first communication unit 51.

Then, the second converter (DAC) 63 converts the digital voice signal, from which noise is removed, into an analog signal, and then, directly transmits the analog signal to the soundcard module 202 of the computer 200 through the second data line 72.

When the analog voice signal is output through the second data line 72, a flag signal for informing an output state of the analog voice signal is output to the in/out port 210 of the computer 200 through the first communication unit 51. When the analog voice signal is directly transmitted to the soundcard module 202 of the computer 200 through the second data line 72, the computer 200 stores the voice signal input into the in/out port 210 through the second data line 72 in a memory, or executes a drive program of the soundcard module 202, thereby outputting the user's voice to the exterior through a speaker of the computer 200.

In addition, as shown in FIG. 6, when the analog voice signal of the microphone 40 is input into the second communication unit 71 and directly transmitted to the soundcard module 202 through the second data line 72, the analog voice signal is transmitted to the in/out port 201 of the computer 200 through the first communication unit 51.

When the analog voice signal is directly transmitted to the soundcard module 202 of the computer 200 through the second communication unit 71 via the second data line 72, the computer 200 stores the voice signal input into the in/out port 201 through the second data line 72 in a memory, or executes a drive program of the soundcard module 202, thereby outputting the user's voice to the exterior through a speaker of the computer 200.

Meanwhile, as shown in FIGS. 7 and 8, the handsfree terminal 90 for connecting a communication terminal such as a mobile phone is disposed at one end of an outer surface of the mouse 100, and electrically connected to the printed circuit board 30.

That is, the handsfree terminal 90 disposed at one end of the outer surface of the mouse is connected to a communication port (not shown) of the communication terminal 300 through an earphone jack 301 for a voice call.

When a voice call of the communication terminal 300 is connected to receive the caller's voice signal at the communication terminal 300 through an antenna, the voice signal is transmitted to the mouse 100 through the earphone jack 301.

As a result, the caller's voice signal transmitted to the mouse 100 is transmitted to the soundcard module 202 of the computer 200 through the exclusive voice transmission line, i.e., the second communication unit 71 and the second data line 72 via the signal processor.

Therefore, the user can use the handsfree function of the mouse 100 and the computer 200, that is, can hear the caller's voice through the speaker of the computer 200.

In this process, the user's voice signal is transmitted to the caller through the antenna via the built-in microphone of the communication terminal 300.

As can be seen from the foregoing, a mouse with a built-in microphone in accordance with the present invention is capable of directly outputting a voice signal of the microphone to a soundcard of a computer through an output line separated from an output line of the mouse, and filtering the noise generated due to operation of the mouse when the voice signal is output. Therefore, even while an application program of the computer is performed through the mouse, a desired voice signal can be transmitted to the computer through the microphone, and sensitivity of the voice signal input into the computer can be improved.

In addition, it is possible to install the microphone in the mouse without a design change of a mouse surface so that the cost required for the design change can be reduced compared to the conventional mouse.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A mouse with a built-in microphone comprising:
a first surface having a left function button, a right function button, and a scroll button;
a second surface having an optical structure for setting coordinates;
a printed circuit board disposed between the first and second surfaces;
a microphone installed between the first and second surfaces and electrically connected to the printed circuit board to receive a voice signal;
a data transmission line for transmitting mouse signals including click signals and a coordinate setting signal from the buttons and the optical structure disposed in the first and second surfaces; and
a signal processor for processing the voice signal input from the microphone,
wherein the voice signal processed by the signal processor is transmitted together with the mouse signals.

2. The mouse with a built-in microphone according to claim 1, wherein the data transmission line comprises a first communication unit for transmitting the mouse signals including the click signals and the coordinate setting signal, and a first data line for connecting the first communication unit to a computer.

3. The mouse with a built-in microphone according to claim 2, wherein the voice signal is added to a standard protocol for transmitting the mouse signals

4. The mouse with a built-in microphone according to claim 1, further comprising a voice signal transmission line for transmitting only the voice signal processed by the signal processor to a computer.

5. The mouse with a built-in microphone according to claim 4, wherein the voice signal transmission line comprises a second communication unit for transmitting the voice signal only, and a second data line for connecting the second communication unit to the computer.

6. The mouse with a built-in microphone according to claim 5, wherein the second data line is connected to a soundcard module mounted in the computer.

7. The mouse with a built-in microphone according to claim 1, wherein the signal processor comprises a first converter (ADC) for converting an analog voice signal recognized through the microphone into a digital signal; and a digital signal processor (DSP) for removing noise input into the microphone.

8. The mouse with a built-in microphone according to claim 7, wherein the signal processor further comprises a second converter (DAC) for converting the digital voice signal, from which the noise is removed, into an analog signal, and transmitting the analog signal to a soundcard module mounted in a computer.

9. A mouse with a built-in microphone comprising:
a first surface having a left function button, a right function button, and a scroll button;
a second surface having an optical structure for setting coordinates;
a printed circuit board disposed between the first and second surfaces;
a microphone installed between the first and second surfaces and electrically connected to the printed circuit board to receive a voice signal; and
a holder for fixing the microphone.

10. The mouse with a built-in microphone according to claim 9, wherein the holder is installed in an inner space of a first hole for protruding the scroll button to the exterior.

11. The mouse with a built-in microphone according to claim 9, wherein the holder is installed in an inner space of a second hole for protruding the optical structure to the exterior.

12. The mouse with a built-in microphone according to claim 9, wherein the holder comprises a connection part for electrically connecting the printed circuit board and the microphone.

13. A mouse with a built-in microphone comprising:
a first surface having a left function button, a right function button, and a scroll button;
a second surface having an optical structure for setting coordinates;
a printed circuit board disposed between the first and second surfaces;
a microphone installed between the first and second surfaces and electrically connected to the printed circuit board to receive a voice signal;
a handsfree terminal for connecting an earphone jack of a communication terminal for a voice call;
a data transmission line for transmitting mouse signals including click signals and a coordinate setting signal from the buttons and the optical structure disposed in the first and second surfaces; and
a signal processor for processing the voice signal input from the microphone and the communication terminal,
wherein the voice signal processed by the signal processor is transmitted together with the mouse signals.

14. The mouse with a built-in microphone according to claim 13, wherein the handsfree terminal installed in the first surface is electrically connected to the printed circuit board.

15. The mouse with a built-in microphone according to claim 13, wherein the handsfree terminal installed in the second surface is electrically connected to the printed circuit board.

16. The mouse with a built-in microphone according to claim 13, wherein the data transmission line comprises a first communication unit for transmitting the mouse signals including the click signals and the coordinate setting signal, and a first data line for connecting the first communication unit to a computer.

17. The mouse with a built-in microphone according to claim 16, wherein the voice signal is added to a standard protocol for transmitting the mouse signals.

18. The mouse with a built-in microphone according to claim 13, further comprising a voice signal transmission line for transmitting only the voice signal processed by the signal processor to a computer.

19. The mouse with a built-in microphone according to claim 18, wherein the voice signal transmission line comprises a second communication unit for transmitting the voice signal only, and a second data line for connecting the second communication unit to the computer.

20. The mouse with a built-in microphone according to claim 19, wherein the second data line is connected to a soundcard module mounted in the computer.

21. The mouse with a built-in microphone according to claim 13, wherein the signal processor comprises a first converter (ADC) for converting an analog voice signal recognized through the microphone into a digital signal; and a digital signal processor (DSP) for removing noise input into the microphone.

22. The mouse with a built-in microphone according to claim 21, wherein the signal processor further comprises a second converter (DAC) for converting the digital voice signal, from which the noise is removed, into an analog signal, and transmitting the analog signal to a soundcard module mounted in a computer.
